(19) United States
(12) Patent Application Publication
(10) Pub. No.: US 2003/0210616 A1
(43) Pub. Date: Nov. 13, 2003

(54) Method for managing play lists in a rewritable storage medium

(76) Inventors: Soung Hyun Um, Anyang-si (KR); Kang Soo Seo, Anyang (KR); Byung Jin Kim, Kyunggi-do (KR); Jea Yong Yoo, Seoul (KR)

Correspondence Address: BIRCH STEWART KOLASCH & BIRCH, PO BOX 747, FALLS CHURCH, VA, 22040-0747, US

(21) Appl. No.: 10/372,226

(22) Filed: Feb. 25, 2003

(30) Foreign Application Priority Data
Feb. 25, 2002 (KR) 02-10008

(51) Int. Cl. G11B 7/085

(52) U.S. Cl. 369/30.09

(57) ABSTRACT

A method for managing play lists for playback control of data streams recorded on an optical disk such as a rewritable high-density storage medium. The method in accordance with the invention records received dubbed audio data pertaining to a data clip recorded on a storage medium and creates a play list for the recorded audio data clip, in which a flag included in the play list is set to ‘1’ to indicate that the audio clip referred to by the play list is auxiliary data. In case of sequential playing of all play lists, the play lists the flag of which is set to ‘1’ are skipped, thereby preventing meaningless playing of audio data with no video or unnecessary repeated playing of dubbed audio data.

### BACKGROUND OF THE INVENTION

1. Field of the Invention

The present invention relates to a method for managing play lists as management information for playback control of data streams recorded on an optical disk such as a rewritable high-density storage medium.

2. Description of the Related Art

DVDs, which are high-density and high-capacity optical disks, are widely used for storing high-quality moving picture data or audio data. There are several different types of DVDs such as a read-only DVD-ROM, a one-time recordable DVD-R, and a rewritable DVD-RAM or DVD-RW. The standardization of data recording formats for recording moving picture and audio data on a rewritable DVD-such as a DVD-RAM and a DVD-RW has been almost completed.

On the other hand, with the start of HD-TV broadcasts the development of rewritable higher-capacity optical disks for recording and reproducing HD-TV broadcasts has been completed. The higher-capacity optical disk has a storage capacity of about 23 GB, 5 times as much as the capacity of a DVD. The development of application specifications for commercializing the higher-capacity storage medium is under way by relevant consumer electronics manufacturers.

An optical disk apparatus capable of receiving HD-TV broadcasts and recording received HD contents on a rewritable optical disk having a capacity of 23 GB comprises a DVR recording system 11, an optical pickup 12, and a control unit 13, as shown in FIG. 1.

Receiving a data stream, for example, a movie clip, the DVR recording system 11 records the received movie clip on a rewritable high-density storage medium 10, creates a play list for the recorded movie clip, and records the created play list as management information. Such a play list created when a data clip is recorded is called a real play list.

A user may select partial intervals of a recorded clip and request the selected intervals to be played. A play list created in response to such a request is called a virtual play list. A virtual play list contains information for referring to each selected interval within a recorded clip.

After a movie clip is recorded, a user may add brief voice comments about some scenes to the recorded clip, which is called an audio dubbing. A real play list is created and recorded also for the dubbed audio data, which is auxiliary data added to the original movie clip.

Unlike the original movie clip, the auxiliary data is meaningless in itself and pertains to the original movie clip, which means that the movie clip and the dependent auxiliary data should be managed distinctly. As a result, there is a need for a special method for managing auxiliary data that takes into account both cases of a linked presentation of a data clip and the auxiliary data pertaining to it and a single presentation of the auxiliary data.

### SUMMARY OF THE INVENTION

To address the above-discussed problem, the present invention provides a method for managing play lists in a rewritable storage medium wherein real play lists referring to auxiliary data are identified and whether to allow the single presentation of the real play lists referring to auxiliary data can be selected.

A method for managing play lists in a rewritable storage medium in accordance with the invention comprises the two steps of receiving and recording auxiliary data pertaining to a clip recorded on a storage medium and creating a play list for the recorded auxiliary data clip and recording the created play list with additional information indicating that the clip referred to by the play list is auxiliary data.

Another method for managing play lists in a rewritable storage medium in accordance with the present invention comprises the three steps of receiving a request for sequentially playing a plurality of play lists, checking the plurality of play lists sequentially to examine whether the data clip referred to by each of the play lists is an auxiliary data clip, and determining whether to play the data clip referred to by each of the play lists, based on the checking result.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 illustrates a brief block diagram of an optical disk apparatus;

FIG. 2 illustrates the relations among a recorded movie clip, a dubbed audio clip pertaining to the movie clip, a virtual play list and real play lists that refer to the movie clip and dubbed audio clip;

FIGS. 3, 4, and 5 illustrate the overall and partial structures of a real play list in accordance with the preferred embodiment of the present invention; and

FIGS. 6 and 7 illustrate exemplary processes of playing play lists in accordance with the preferred embodiment of the present invention.

### DETAILED DESCRIPTION OF THE PREFFERRED EMBODIMENT

In order that the invention may be fully understood, preferred embodiments thereof will now be described with reference to the accompanying drawings.

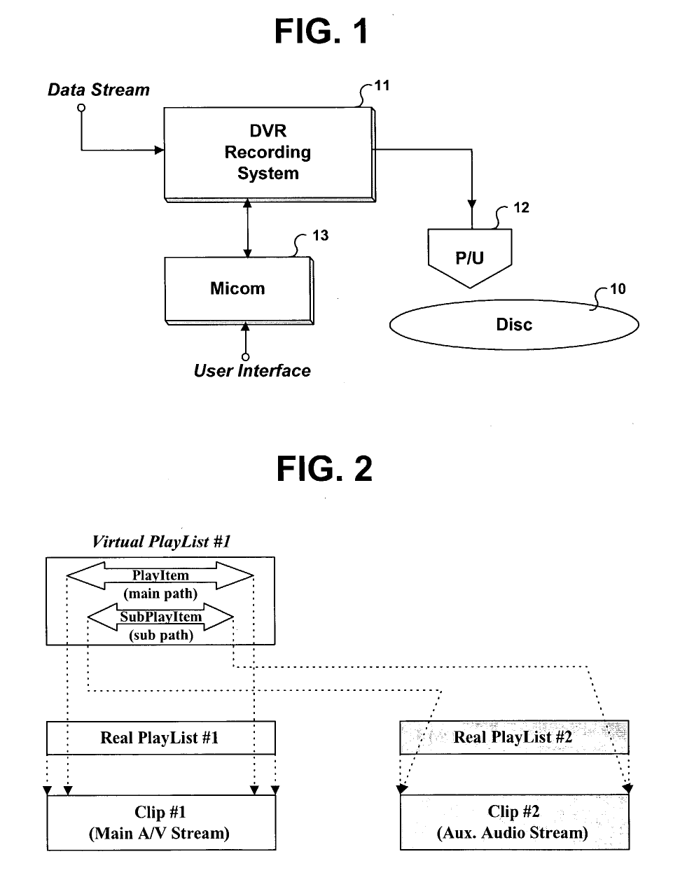

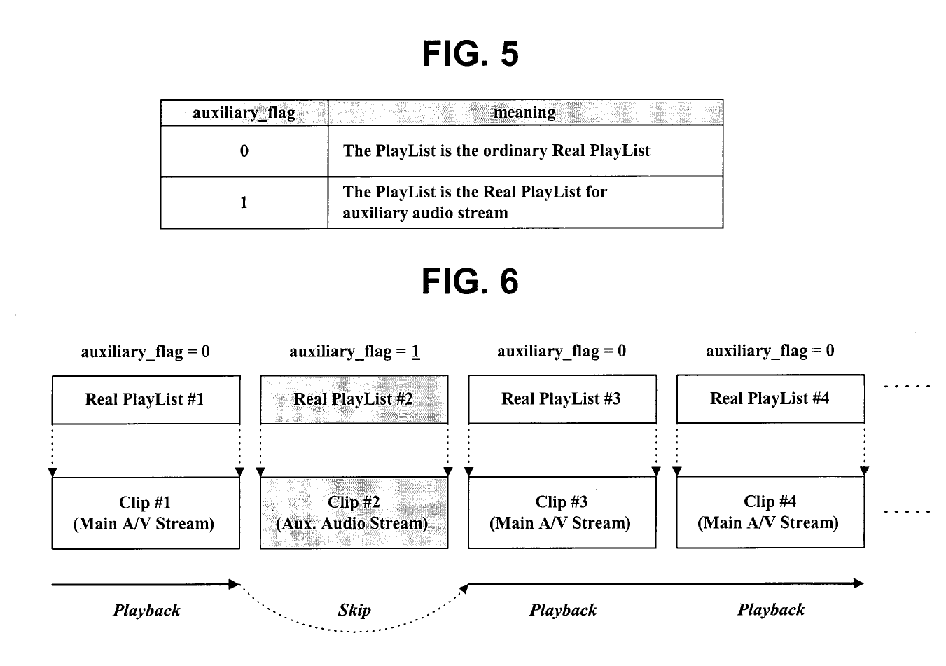

The optical disk apparatus comprising the DVR recording system 11, optical pickup 12, and the control unit 13 as shown in FIG. 1 records an incoming data stream, for example, a video/audio clip ‘Clip #1’, on the rewritable storage medium 10. Simultaneously, the optical disk apparatus creates a real play list Real PlayList #1 for playback control of ‘Clip #1’ and records it on the storage medium 10 as management information. FIGS. 3 to 5 illustrate the structure of such a real play list.

If a user selects a partial or total interval of the recorded clip ‘Clip #1’ and requests recording of auxiliary data such as dubbed audio data for the selected interval, the control unit 13 records the incoming auxiliary data as a new clip ‘Clip #2’ through the DVR recording system 11. Also, the control unit 13 creates and records a real play list Real PlayList #2 that refers to ‘Clip #2’.

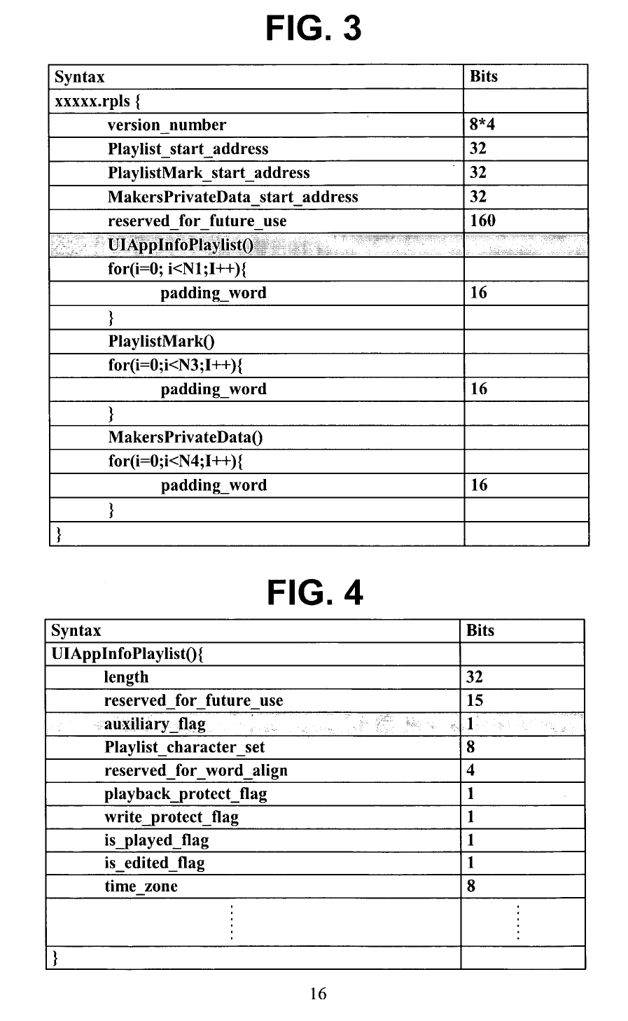

Subsequently, the control unit 13 creates a virtual play list Virtual PlayList #1 containing a play item that refers to the selected interval of ‘Clip #1’ and another play item that refers to the total interval of ‘Clip #2’ as depicted in FIG. 2 and records the created Virtual PlayList #1 as management information of the storage medium, whereby the video/audio clip Clip #1 and its auxiliary data clip ‘Clip #2’ are linked.

In the virtual play list, the play item referring to the video/audio clip acts as a main path to presentation and the play item referring to the auxiliary data acts as a sub-path to presentation.

If a user selects the virtual play list, the control unit 13 presents the video/audio clip ‘Clip #1’ and the dubbed audio clip ‘Clip #2’ referred to by the virtual play list together. If a user selects a real play list, the control unit 13 outputs the video/audio clip ‘Clip #1’ or the dubbed audio clip ‘Clip #2’ referred to by the selected real play list. The play of only the dubbed audio clip by selection of Real PlayList #2 is allowed because it is necessary for special purposes such as verification of the dubbed audio clip.

If sequential presentation of all real play lists or all real and virtual play lists is requested, the control unit 13 reads real play lists or all real and virtual play lists recorded in the management information area of the storage medium 10 and sequentially presents the clips referred to by the play lists.

Because a real play list is also created and recorded for an auxiliary data clip such as a dubbed audio clip, auxiliary data clips are also played when all real play lists or all play lists are played sequentially.

In the case where all play lists are sequentially played, video/audio clips and auxiliary data clips are presented by playing virtual play lists and then the auxiliary data clips with no video data are presented again by playing the real play lists referring to the auxiliary data clips.

Similarly, in the case where all real play lists are sequentially played, auxiliary data clips with no video data are presented after video/audio clips are played. In these two cases, however, the presentation of only the auxiliary data clips is totally useless to the user in that it is not intended for special purposes such as verification of the auxiliary data clips.

To prevent the meaningless presentation of auxiliary data, a real play list includes a field, auxiliary_flag, for indicating that the referenced data clip is an auxiliary data clip, as depicted in FIG. 4.

After recording an auxiliary data clip, the control unit 13 creates a real play list that refers to the recorded data clip and sets the field, auxiliary_flag, to ‘1’. As depicted in FIG. 5, if auxiliary_flag of a real play list is set to ‘0’, the real play list refers to an ordinary video/audio clip and otherwise the real play list refers to an auxiliary data clip.

A real play list is written in a file the extension of which is ‘rpls’. FIG. 3 depicts the structure of a real play list, which includes the fields of a version number (version_number), a play list start address (PlayList_start_address), a play list mark start address (PlayListMark_start_address), a maker's private data start address (MakersPrivateData_{—}start_address), and the user interface application information play list (UIAppInfoPlayList) table.

The user interface application information play list (UIAppInfoPlayList) table includes the fields of a data length (Length), a play list character set (PlayList_character_set), a playback protect flag (playback_protect_flag), a write protect flag (write_protect_flag), the above-mentioned auxiliary_flag, and other information, as shown in FIG. 4.

If it is requested to play all real play lists or all play lists sequentially, the control unit 13 refers to the above information of the real play lists.

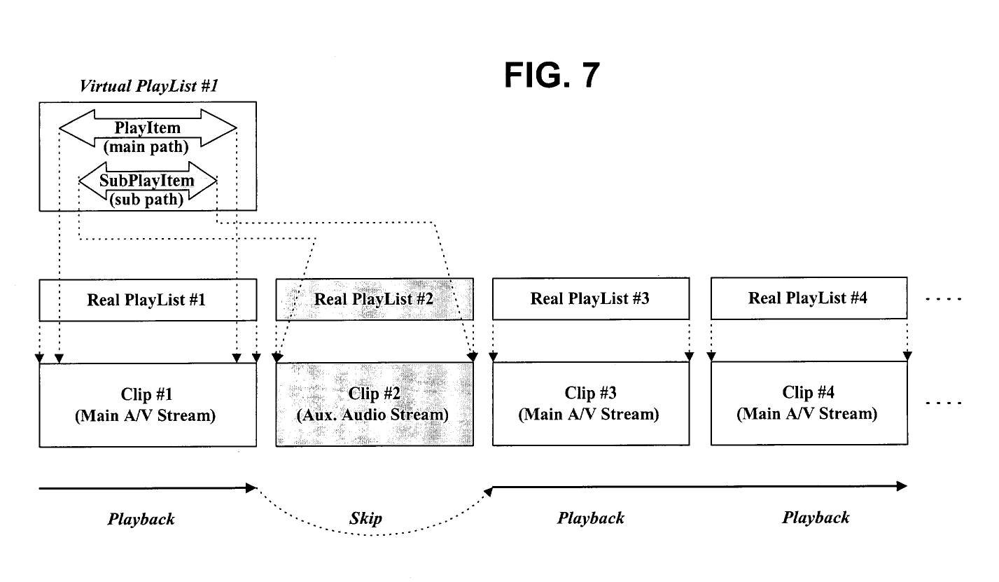

Receiving a request for sequential playing of all real play lists, the control unit 13 examines the value of auxiliary_flag contained in each of the real play lists before playing the real play lists. If the value of a real play list is ‘0’, it means that the data clip referred to by the real play list is not an auxiliary data clip and therefore the data clip is normally presented. If the value is ‘1’, the data clip referred to by the real play list is not played because the data clip is auxiliary data. In the example of FIG. 6, auxiliary_flag of the second real play list Real PlayList 42 is ‘1’ and thus the auxiliary audio data clip ‘Clip #2’ referred to by Real PlayList #2 is skipped.

In summary, if it is requested to play all real play lists sequentially in the example of FIG. 6, the second real play list that refers to the dubbed audio clip ‘Clip #2’ is skipped and the first, third, and forth real play lists are played sequentially.

In the case where it is requested to sequentially play all play lists, the second real play list is skipped likewise.

In FIG. 7, a virtual play lists refers to a partial interval of ‘Clip #1’ as a main path and refers to the total interval of ‘Clip #2’ as a sub-path. If a user requests a sequential play of all play lists, the control unit 13 checks all play lists sequentially from the management information area of the storage medium 10. If a data clip is referred to by both real and virtual play lists, the user-defined virtual play list is played first.

In FIG. 7, therefore, the control unit 13 first plays Virtual PlayList #1, in which the partial interval of ‘Clip #1’ referred to by the main path play item and the total interval of ‘Clip #2’ referred to by the sub-path play item are presented simultaneously. Because the next play list to be played is a real play list, Real PlayList #1, the control unit 13 examines the value of auxiliary_flag of Real PlayList #1. As the value is ‘0’, the total interval of ‘Clip #1’ referred to by Real PlayList #1 is played.

As in FIG. 6, the value of auxiliary flag of Real PlayList #2 is ‘1’ and therefore the referenced clip ‘Clip #2’ is skipped, whereby unnecessary repeated presentation of auxiliary data is prevented.

Both of the third and forth real play lists have auxiliary_flag set to ‘0’ and therefore the referenced clips are both played.

The method for managing play lists in a rewritable storage medium in accordance with the invention skips real play lists that refer to auxiliary data clips when playing all real play lists or all play lists, thereby preventing meaningless playing of audio data with no video or unnecessary repeated playing of auxiliary data clips.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method for managing play lists in a rewritable storage medium, comprising the steps of:
receiving and recording auxiliary data pertaining to a clip recorded on a storage medium; and
creating a play list for the recorded auxiliary data clip and recording the created play list with additional information indicating that the clip referred to by the play list is auxiliary data.

2. The method set forth in claim 1, wherein said information is a 1-bit flag.

3. The method set forth in claim 1, wherein said information is stored in an information area related to user interface of said play list.

4. The method set forth in claim 1, wherein said auxiliary data is audio data recorded for dubbing the recorded clip.

5. A method for managing play lists in a rewritable storage medium, comprising the steps of:
receiving a request for sequentially playing a plurality of play lists;
checking the plurality of play lists sequentially to examine whether the data clip referred to by each of the play lists is an auxiliary data clip; and
determining whether to play the data clip referred to by each of the play lists, based on the checking result.

6. The method set forth in claim 5, wherein said determining step skips playing of the data clip referred to by the play list if the data clip is an auxiliary data clip.

7. The method set forth in claim 6, wherein if the play list refers to another clip as well as the data clip, said determining step plays both of the referenced clips together without skipping playing the play list though the data clip is an auxiliary data clip.

8. The method set forth in claim 5, wherein said checking step checks information included in each of the play lists, the information indicating whether the referenced data clip is an auxiliary data clip.

9. The method set forth in claim 8, wherein said information is a 1-bit flag.

10. The method set forth in claim 8, wherein said information is stored in an information area related to user interface of said play list.

11. The method set forth in claim 5, wherein said plurality of play lists comprises only first-type play lists created and recorded by data recording or comprises first-type play lists and second-type play lists created by a user's selection of preferred intervals.

12. The method set forth in claim 11, wherein said checking step and determining step are performed only when the play list is said first-type play list.

13. The method set forth in claim 5, wherein said auxiliary data clip is an audio data clip recorded for dubbing a recorded video clip.

14. A storage medium, containing at least one data clip, an auxiliary data clip pertaining to one of the data clips, and play lists that refer to the recorded clips, wherein the play list for the auxiliary data clip includes information indicating that the referenced clip is auxiliary data.

15. The storage medium set forth in claim 14, said play lists are first-type play lists created and recorded by data recording or second-type play lists created by a user's selection of preferred intervals.

16. The storage medium set forth in claim 14, wherein said information is included in case that the play list is said first-type play list.

17. The storage medium set forth in claim 14, wherein said information is stored in an information area related to user interface of the play list.
